(19) United States
(12) Patent Application Publication
(10) Pub. No.: US 2026/0161233 A1
(43) Pub. Date: Jun. 11, 2026

(54) INFORMATION PROCESSING APPARATUS

(71) Applicant: CANON KABUSHIKI KAISHA, Tokyo (JP)

(72) Inventors: TOSHIHIRO MOCHIZUKI, Kanagawa (JP); NAOTO OKUMURA, Kanagawa (JP)

(21) Appl. No.: 19/384,303

(22) Filed: Nov. 10, 2025

(30) Foreign Application Priority Data
Dec. 11, 2024 (JP) 2024-216407

(51) Int. Cl. G06F 3/01

(52) U.S. Cl. CPC G06F 3/016; G06F 3/011

(57) ABSTRACT

An information processing apparatus according to the present disclosure includes a processor, and a memory storing a program which, when executed by the processor, causes the information processing apparatus to execute control processing of controlling display of a virtual space such that a predetermined touch corresponding to a haptic sensation that is not presentable to a user from a haptic device to be used does not occur as a touch of the user with respect to a virtual object in the virtual space.

### BACKGROUND

### Field of the Technology

The present disclosure relates to an information processing apparatus, and more particularly, to a technology for presenting a haptic sensation in a virtual space to a user.

### Description of the Related Art

Japanese Patent Laid-Open No. 2019-525344 discloses aerial haptic sensation feedback (aerial haptics) using a continuous distribution of sound energy called a “sound field”. By using the aerial haptics, a user can obtain a haptic sensation related to a virtual space such as an augmented reality (AR) space or a mixed reality (MR) space without wearing a haptic glove or the like.

However, in the aerial haptics, there is an upper limit or a lower limit in an intensity of an ultrasonic wave that can be output from a haptic device that forms a sound field, and thus, a haptic sensation that is presentable from the haptic device to the user is limited. Other types of haptic feedback also limit the haptic sensation that is presentable to the user from the haptic device. Thus, a haptic sensation suitable for the user is not presentable from the haptic device, and the user may feel a sense of discomfort. For example, when the user suddenly moves a finger, a haptic sensation deviated from a haptic sensation assumed by the user is presented to the user, and the user may feel a sense of discomfort.

### SUMMARY

The present disclosure provides a technology capable of suppressing presentation of a haptic sensation with a sense of discomfort.

The present disclosure in its first aspect provides an information processing apparatus including a processor, and a memory storing a program which, when executed by the processor, causes the information processing apparatus to execute control processing of controlling display of a virtual space such that a predetermined touch corresponding to a haptic sensation that is not presentable to a user from a haptic device to be used does not occur as a touch of the user with respect to a virtual object in the virtual space.

The present disclosure in its second aspect provides an information processing method including displaying a virtual space, and controlling display of the virtual space such that a predetermined touch corresponding to a haptic sensation that is not presentable to a user from a haptic device to be used does not occur as a touch of the user with respect to a virtual object in the virtual space.

The present disclosure in its third aspect provides a non-transitory computer readable medium that stores a program, wherein the program causes a computer to execute an information processing method including displaying a virtual space, and controlling display of the virtual space such that a predetermined touch corresponding to a haptic sensation that is not presentable to a user from a haptic device to be used does not occur as a touch of the user with respect to a virtual object in the virtual space.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a display system.

FIG. 2 is an external view of a display device.

FIG. 3 is a schematic diagram of a haptic sensation generation unit.

FIG. 4 is a flowchart of aerial haptics processing.

FIG. 5A is a schematic diagram of a use state of the display system.

FIGS. 5B to 5H are schematic diagrams of a combined image.

### DESCRIPTION OF THE EMBODIMENTS

An embodiment of the present disclosure will be described.

### System Configuration

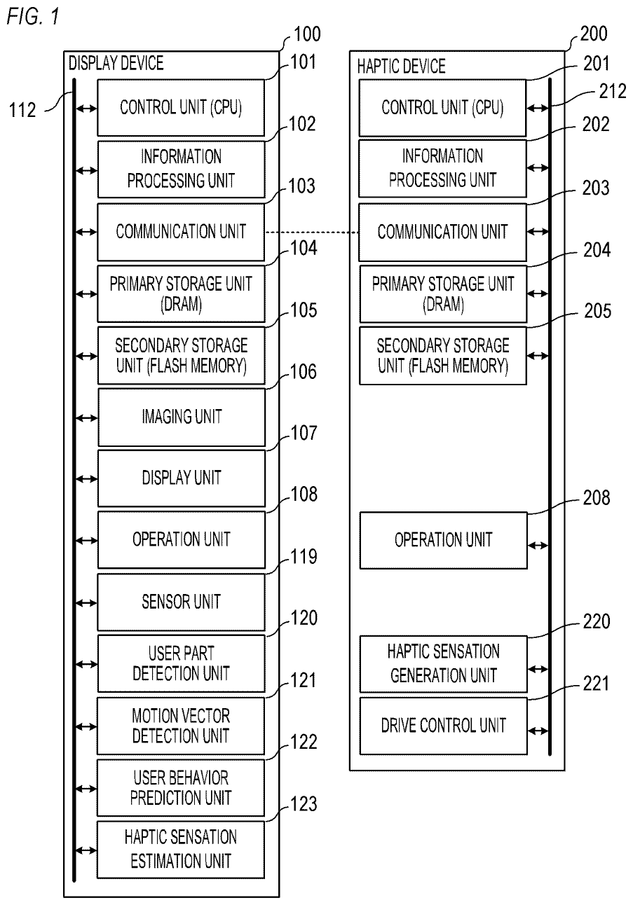

FIG. 1 is a block diagram illustrating a configuration of a display system according to the present embodiment. The display system in FIG. 1 includes a display device 100 and a haptic device 200 (haptic sensation generation device).

### Display Device

As illustrated in FIG. 1, the display device 100 includes a control unit 101, an information processing unit 102, a communication unit 103, a primary storage unit 104, a secondary storage unit 105, an imaging unit 106, a display unit 107, and an operation unit 108. Further, the display device 100 includes a sensor unit 119, a user part detection unit 120, a motion vector detection unit 121, a user behavior prediction unit 122, and a haptic sensation estimation unit 123. These constituents are connected to a bus 112, and data is transmitted and received between the constituents via the bus 112.

The control unit 101 is, for example, a CPU, and controls each unit of the display device 100.

The information processing unit 102 is a processing circuit (arithmetic unit) that performs various types of information processing (arithmetic processing) such as four arithmetic operations, matrix arithmetic operations, and physical arithmetic operations. For example, the information processing unit 102 performs arithmetic processing of image data obtained by the imaging unit 106 (arithmetic processing of obtaining various evaluation values regarding the image data, and the like), arithmetic processing of data acquired by the communication unit 103, and the like.

The communication unit 103 is a communication interface that performs communication with an external device.

The primary storage unit 104 is, for example, a DRAM and temporarily stores data used by the control unit 101 and the information processing unit 102.

The secondary storage unit 105 is, for example, a flash memory and stores data used by the control unit 101 and the information processing unit 102, a processing result (for example, an encoded recorded image) of the information processing unit 102, and the like.

The imaging unit 106 includes, for example, an optical lens, an imaging element (image sensor), and an A/D converter and converts light from the outside (object) into digital data (image data).

The display unit 107 is a display that displays various images. The display unit 107 may have a touch panel that receives a touch operation with a user's finger, a stylus, or the like. The display unit 107 provides a virtual space such as an augmented reality (AR) space or a mixed reality (MR) space to a user. In the virtual space, the user can touch a virtual object. A position and an orientation of a part of the user in the virtual space are linked to a position and an orientation of the part in a real space. As the part of the user in the virtual space, an image obtained by imaging the part may be displayed, or a three-dimensional model (CG) corresponding to the part may be displayed. In a case where the display device 100 is an optical see-through type display device, the part of the user in the virtual space may be the part of the user itself in the real space.

The operation unit 108 includes an operation member that receives a user operation and includes, for example, a button and a dial. The above-described touch panel is also an example of the operation member. When a user operation is performed on the operation members, the control unit 101 performs control in response to the user operation. The communication unit 103 may acquire a signal in response to a user operation on the external device, and the control unit 101 may perform control in accordance with a signal.

The sensor unit 119 includes various sensors. For example, the sensor unit 119 includes a gyro sensor, an acceleration sensor, and a global positioning system (GPS) sensor, and acquires information of an angular velocity and a current position of the display device 100. The information of the angular velocity and the current position of the display device 100 may be acquired in a method different from a method using the gyro sensor, the acceleration sensor, and the GPS sensor.

The user part detection unit 120 acquires information of the position and orientation (posture) of the user part by detecting the user part (predetermined part of the user) from the image data (image obtained by imaging the real space) obtained by the imaging unit 106. A method for detecting the user part is not particularly limited, and the user part may be detected by, for example, feature extraction processing using a convolutional neural network (CNN). Various parts can be detected by switching weights in the CNN. In the present embodiment, the user part that is a detection target is a hand, but the detection target is not limited to the hand, and may be a finger, an arm, a face, or the like. One part may be detected, or a plurality of parts may be detected.

The motion vector detection unit 121 detects feature points of an image from image data of a current frame obtained by the imaging unit 106, and detects motion vectors of feature points from a past frame (for example, a previous frame of a current frame) to the current frame. Three-dimensional coordinates of the feature points are acquired, and a three-dimensional motion vector is acquired. A method for detecting the motion vector is not particularly limited, and the motion vector may be detected by a known method such as a correlation method or a block matching method.

The user behavior prediction unit 122 predicts a future behavior of the user on the basis of the behavior of the user up to the present. The behavior of the user may be interpreted as a temporal change in the position and orientation of the user part. A method for predicting the behavior of the user is not particularly limited. In the present embodiment, the user behavior prediction unit 122 predicts a position, an orientation, and a speed of the user part in a future frame on the basis of the pieces of information acquired by the user part detection unit 120, the motion vector detection unit 121, and the sensor unit 119. The future frame is, for example, a frame next to the current frame. In the present embodiment, it is assumed that the imaging unit 106 is fixed to the display device 100. Thus, the motion vector detected by the motion vector detection unit 121 indicates a relative motion with respect to the display device 100. The user behavior prediction unit 122 excludes a translation component and a rotation component of the display device 100 from the motion vector detected by the motion vector detection unit 121 on the basis of the angular velocity and the current position of the display device 100 acquired by the sensor unit 119. As a result, the speed of the user part is acquired. The user behavior prediction unit 122 predicts a position, an orientation, and a speed of the user part in the future frame on the basis of the acquired speed of the user part and the position and orientation of the user part detected by the user part detection unit 120.

Note that, the motion vector detection unit 121 may detect a temporal change of the motion vector up to the present such that the user behavior prediction unit 122 considers a more detailed behavior as the behavior of the user up to the present. The user behavior prediction unit 122 may predict the behavior of the user in a period for a plurality of future frames. At that time, a prediction result for a first frame that is a future frame may be used for prediction for a second frame after the first frame.

The haptic sensation estimation unit 123 predicts a touch of the user with the virtual object on the basis of the future behavior of the user predicted by the user behavior prediction unit 122, and estimates the haptic sensation corresponding to the touch. In a case where a position and an orientation of the virtual object change with time, the prediction of the touch and the estimation of the haptic sensation are performed in further consideration of the behavior of the virtual object. The prediction of the touch and the estimation of the haptic sensation are not particularly limited. In the present embodiment, it is assumed that the haptic sensation estimation unit 123 predicts the touch of the user with respect to the virtual object and estimates a haptic sensation intensity corresponding to the touch by performing collision simulation by physical arithmetic operation. The following data and information are used for collision simulation. Information other than the information acquired by the user behavior prediction unit 122 may be stored in advance in the primary storage unit 104 or may be acquired from an outside by the communication unit 103.
Data of three-dimensional model of user part
Information of weight of user part (three-dimensional model)
Information acquired by user behavior prediction unit 122 (information of position, orientation, and speed of user part in future frame)
Data of three-dimensional model of virtual object
Information of weight of virtual object (three-dimensional model)
Information of behavior of virtual object

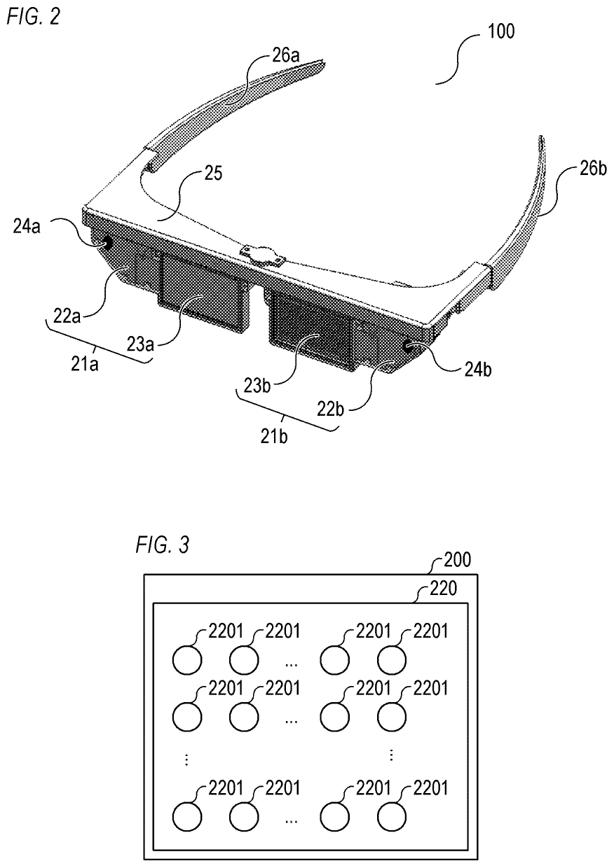

FIG. 2 is an external view of the display device 100. The display device 100 is a video see-through type display device, and includes a frame, two display units 21a and 21b corresponding to the display unit 107, and two imaging units 24a and 24b corresponding to the imaging unit 106. The frame includes a rim 25 having a lower surface to which the display units 21a and 21b are bonded, and temples 26a and 26b bonded to both sides of the rim 25. The imaging units 24a and 24b image a front side (real space) of the display device 100. In the display unit 21a, light from a display element (not illustrated) is guided to a right eye of the user wearing the display device 100 by an image projection unit 22a and a light guide unit 23a. The light guided to the right eye of the user represents, for example, an image with an image (image of the real space) imaged by the imaging unit 24a as a background. Similarly, in the display unit 21b, light from a display element (not illustrated) is guided to a left eye of the user wearing the display device 100 by an image projection unit 22b and a light guide unit 23b. The light guided to the left eye of the user represents, for example, an image with an image (image of the real space) imaged by the imaging unit 24b as a background. Note that, the optical see-through type display device may be used as the display device 100. In the case of the optical see-through type display device, the display device 100 may not include the imaging units 24a and 24b. The user can visually recognize the front side of the display device 100 (the real space itself that is not the image) via the display units 21a and 21b. The user can visually recognize a video displayed on the display units 21a and 21b and the front side of the display device 100 at the same time.

### Haptic Device

As illustrated in FIG. 1, the haptic device 200 includes a control unit 201, an information processing unit 202, a communication unit 203, a primary storage unit 204, a secondary storage unit 205, an operation unit 208, a haptic sensation generation unit 220, and a drive control unit 221. The constituents are connected to a bus 212, and data is transmitted and received between the constituents via the bus 212.

The control unit 201 is, for example, a CPU, and controls each unit of the haptic device 200.

The information processing unit 202 is a processing circuit (arithmetic unit) that performs various types of information processing (arithmetic processing) such as four arithmetic operations, matrix arithmetic operations, and physical arithmetic operations. For example, the information processing unit 202 performs arithmetic processing or the like of data acquired by the communication unit 203.

The communication unit 203 is a communication interface that performs communication with an external device.

The primary storage unit 204 is, for example, a DRAM and temporarily stores data used by the control unit 201 and the information processing unit 202.

The secondary storage unit 205 is, for example, a flash memory and stores data used by the control unit 201 and the information processing unit 202, a processing result of the information processing unit 202, and the like.

The operation unit 208 includes an operation member that receives a user operation and includes, for example, a button and a dial. When a user operation is performed on the operation members, the control unit 201 performs control in response to the user operation. The communication unit 203 may acquire a signal in response to a user operation on the external device, and the control unit 201 may perform control in accordance with a signal.

The haptic sensation generation unit 220 outputs an ultrasonic wave for presenting a haptic sensation to the user.

The drive control unit 221 drives the haptic sensation generation unit 220 (haptics driver 2201 to be described later) in accordance with a haptic sensation signal received by the communication unit 203. The haptic sensation signal includes frequency information, intensity information, positional information, and synchronization information. The drive control unit 221 drives the haptic sensation generation unit 220 such that an ultrasonic wave having a frequency indicated by the frequency information and an intensity indicated by the intensity information reaches a position indicated by the positional information and the haptic sensation is presented in synchronization with the display on the display device 100.

FIG. 3 is a schematic diagram illustrating a configuration of the haptic sensation generation unit 220. The haptic sensation generation unit 220 includes a plurality of haptics drivers 2201 arrayed two-dimensionally. The haptics driver 2201 is, for example, an ultrasonic transducer. The vibration of each haptics driver 2201 is individually controlled, and thus, a desired haptic sensation can be expressed.

### Communication Between Display Device and Haptic Device

Communication between the display device 100 and the haptic device 200 is performed by using the communication unit 103 and the communication unit 203. The display device 100 transmits a haptic sensation reproduction signal request to the haptic device 200. When the haptic sensation reproduction signal request is received from the display device 100, the haptic device 200 transmits a haptic sensation reproduction signal to the display device 100.

The haptic sensation reproduction signal request is a signal requesting the haptic sensation reproduction signal. The haptic sensation reproduction signal is a signal indicating information of the haptic device, and is, for example, a signal indicating a haptic sensation that is presentable from the haptic device 200 to the user. In the present embodiment, the haptic sensation reproduction signal indicates frequency range information, intensity range information, and region information for each type of haptic sensation, such as “warm”, “cold”, “hard”, “soft”, “smooth”, and “rough”. The region information indicates a three-dimensional region in which a haptic sensation is presentable to the user. The frequency range information indicates, for each position within a region indicated by the region information, a range (upper limit and lower limit) of a frequency of the ultrasonic wave corresponding to the haptic sensation that is presentable to the user. The intensity range information indicates, for each position within a region indicated by the region information, a range (upper limit and lower limit) of intensity of the ultrasonic wave corresponding to the haptic sensation that is presentable to the user.

When the haptic sensation to be presented to the user is determined, the display device 100 transmits the haptic sensation signal to the haptic device 200. When the haptic sensation signal is received, the haptic device 200 presents the haptic sensation to the user by driving each haptics driver 2201 according to the haptic sensation signal.

### Aerial Haptics Processing

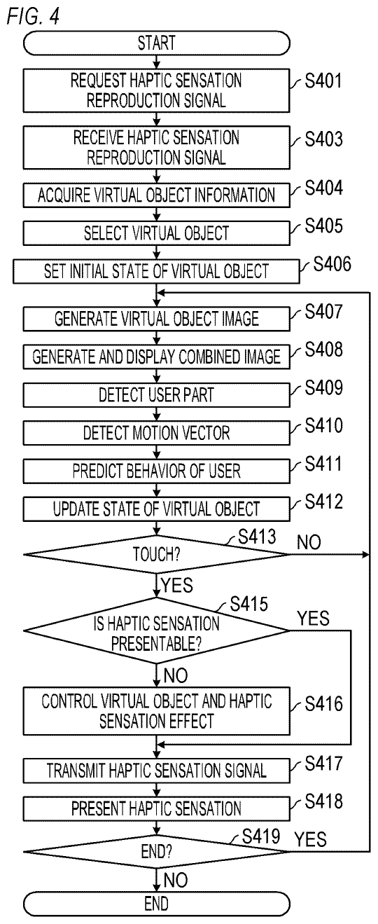

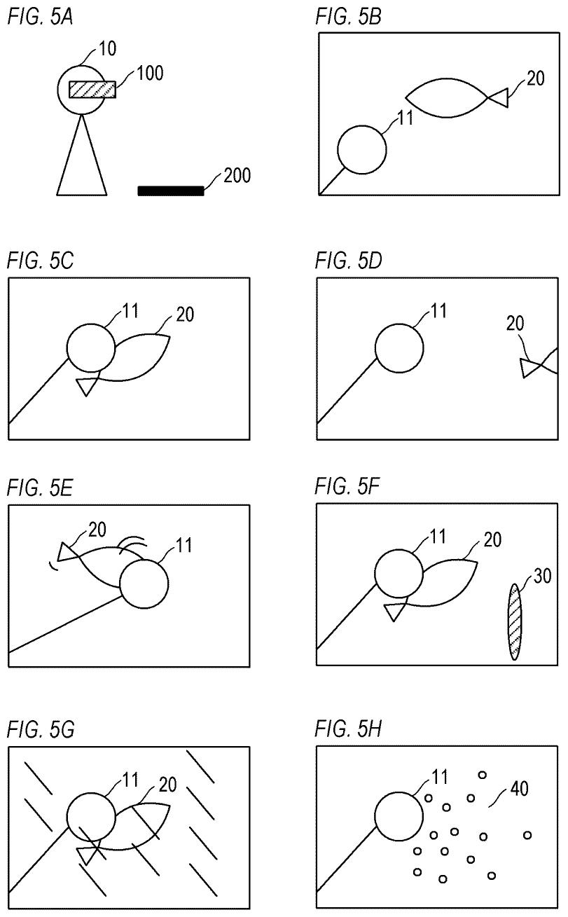

FIG. 4 is a flowchart of aerial haptics processing performed by the display system according to the present embodiment. For example, when the display device 100 and the haptic device 200 are activated, the display device 100 executes an application for providing the virtual space to the user, or the like, and the connection between the display device 100 and the haptic device 200 is established, the aerial haptics processing of FIG. 4 is started. When the aerial haptics processing of FIG. 4 is executed, the user 10 disposes the haptic device 200 in the vicinity of the user 10 and wears the display device 100 on the head as illustrated in FIG. 5A.

In step S401, the control unit 101 of the display device 100 transmits the haptic sensation reproduction signal request to the haptic device 200 via the communication unit 103.

In step S403, the control unit 101 receives the haptic sensation reproduction signal from the haptic device 200 via the communication unit 103, and stores the received haptic sensation reproduction signal in the secondary storage unit 105.

In step S404, the control unit 101 acquires virtual object information indicating a three-dimensional model, a material, a mass, a behavior pattern, and the like of the virtual object from a database (not illustrated) on a cloud via the communication unit 103. Here, the behavior pattern may indicate one or more behaviors such as the virtual object approaching the user, the virtual object escaping from the user, and the virtual object playing alone, and may indicate a change in the position, orientation, expression, and the like of the virtual object. In the present embodiment, the virtual object information includes information of a plurality of virtual objects. The virtual object information may be stored in the secondary storage unit 105 in advance.

In step S405, the control unit 101 selects one or more virtual objects from a plurality of virtual objects indicated by the virtual object information acquired in step S404. A method for selecting the virtual object is not particularly limited. For example, the control unit 101 displays a list of the plurality of virtual objects indicated by the virtual object information on the display unit 107, and selects a designated virtual object in accordance with a user operation of designating one or more virtual objects by using the operation unit 108. The control unit 101 may automatically select the virtual object in accordance with an area of the virtual space visually recognized by the user.

In step S406, the control unit 101 sets an initial state on the basis of the information of the virtual object acquired in step S404, as a state (position, orientation, shape, behavior, light source, or the like) of the virtual object selected in step S405.

In step S407, the control unit 101 controls the information processing unit 102 on the basis of the set state of the virtual object, and generates a virtual object image corresponding to the position and orientation of the user (display device 100). A method for generating the virtual object image is not particularly limited. For example, a two-dimensional virtual object image is generated by arranging a three-dimensional model of the virtual object in the virtual space in a state of the virtual object being set and performing coordinate deformation, geometric deformation, or the like in accordance with the position and orientation of the user (display device 100).

In step S408, the control unit 101 controls the information processing unit 102 to combine (superimpose) the virtual object image generated in step S407 with the image (real space image obtained by imaging the real space) obtained by the imaging unit 106. As a result, a combined image obtained by combining the virtual object image with the real space image is generated. Then, the control unit 101 displays the combined image on the display unit 107. FIG. 5B is a schematic diagram illustrating an example of the combined image. In the combined image of FIG. 5B, a hand 11 of the user 10 and a fish 20 of the virtual object are displayed.

In step S409, the control unit 101 controls the user part detection unit 120 to detect a position and an orientation of the hand of the user from the real space image.

In step S410, the control unit 101 controls the motion vector detection unit 121 to detect the motion vector of the feature point from the real space image.

In step S411, the control unit 101 controls the user behavior prediction unit 122 to predict the position, orientation, and speed of the hand of the user in the future frame. For the prediction, the position and orientation of the hand detected in step S409, the motion vector detected in step S410, and the angular velocity and the current position of the display device 100 acquired by the sensor unit 119 are used.

In step S412, the control unit 101 updates the set state of the virtual object on the basis of the behavior pattern of the virtual object.

In step S413, the control unit 101 controls the haptic sensation estimation unit 123 to predict whether or not the touch of the hand of the user with the virtual object occurs, and to estimate the haptic sensation corresponding to the touch. In a case where the touch occurs, the processing proceeds to step S415, and otherwise, the processing proceeds to step S407. For example, the haptic sensation intensity is estimated by collision simulation on the basis of the position, orientation, and speed of the hand predicted in step S411 and a state of the virtual object updated in step S412. Then, it is determined that the touch occurs in a case where the haptic sensation intensity is greater than 0, and it is determined that the touch does not occur in a case where the haptic sensation intensity is 0.

In step S415, the control unit 101 determines whether or not the haptic sensation estimated in step S413 is a haptic sensation that is presentable to the user from the haptic device 200. The haptic sensation that is presentable to the user from the haptic device 200 can be grasped from the haptic sensation reproduction signal received in step S403. In a case where the estimated haptic sensation is presentable, the processing proceeds to step S417, and otherwise (in a case where the estimated haptic sensation is not presentable), the processing proceeds to step S416. For example, the control unit 101 determines whether or not an intensity of an ultrasonic wave corresponding to the estimated haptic sensation intensity is within the intensity range indicated by the intensity range information. In a case where the intensity of the ultrasonic wave is within the intensity range, the control unit 101 determines that the estimated haptic sensation is presentable, and otherwise, the control unit determines that the estimated haptic sensation is not presentable.

In step S416, the control unit 101 controls the display of the virtual space such that a touch (predetermined touch) corresponding to a haptic sensation that is not presentable to the user from the haptic device 200 does not occur as the touch of the user with the virtual object. A specific control method of the display of the virtual space will be described later.

In step S417, the control unit 101 transmits a haptic sensation signal indicating the estimated haptic sensation (the haptic sensation corresponding to the touch between the virtual object and the user after the control is performed in a case where the control in step S416 is performed) to the haptic device 200 via the communication unit 103.

In step S418, the control unit 201 of the haptic device 200 controls the drive control unit 221 on the basis of the haptic sensation signal transmitted in step S417 to drive the haptic sensation generation unit 220 (haptics driver 2201) to present the haptic sensation to the user.

In step S419, the control unit 101 and the control unit 201 determine whether or not to end the aerial haptics processing of FIG. 4. For example, when the connection between the display device 100 and the haptic device 200 is canceled by an instruction to turn off the power of the display device 100 or the haptic device 200 or an instruction to end the application that provides the virtual space to the user, the aerial haptics processing is ended. In a case where the aerial haptics processing is not ended, the processing proceeds to step S407.

A specific example of the processing (control) in step S416 will be described. FIGS. 5C to 5H are schematic diagrams illustrating an example of the combined image.

FIG. 5C illustrates an example of the combined image in a case where the processing of step S416 is not performed. The hand 11 of the user 10 is touching the rear of the fish 20 of the virtual object. In this case, a rough haptic sensation of scales is to be presented to the user 10 (hand 11), but it is assumed that the haptic device 200 cannot present such a haptic sensation. Thus, a haptic sensation separated from the rough haptic sensation is presented to the user, and the user feels a sense of discomfort.

In the present embodiment, the behavior of the object is controlled such that the situation illustrated in FIG. 5C does not occur. For example, in a case where the situation of FIG. 5C is predicted, a behavior of the fish 20 is controlled such that a touch of the hand 11 with the fish 20 does not occur. In FIG. 5D, the behavior of the fish 20 is controlled such that the fish 20 escapes (moves away) from the hand 11. As a result, the haptic sensation is not presented to the user 10 (hand 11), and the sense of discomfort of the user can be suppressed.

In a case where the situation of FIG. 5C is predicted, the display of the virtual space may be controlled such that the touch of the hand 11 with respect to the fish 20, which is not the touch of FIG. 5C, is performed. It is assumed that the haptic device 200 can present a smooth haptic sensation of the head of the fish 20 to the user 10 (hand 11). In FIG. 5E, the behavior of the fish 20 is controlled such that the head of the fish 20 touches the hand 11. As a result, it is possible to present the smooth haptic sensation with no sense of discomfort to the user 10 (hand 11). Note that, a portion of the fish 20 to be touched with the hand 11 may be any portion corresponding to the haptic sensation that is presentable by the haptic device 200, and is not limited to the head of the fish 20.

It is assumed that the reason why the haptic device 200 cannot present the haptic sensation corresponding to the touch in FIG. 5C is that a scene in FIG. 5C is a cold scene. When the scene in FIG. 5C is a warm scene, it is assumed that the haptic device 200 can present the haptic sensation corresponding to the touch of FIG. 5C to the user 10 (hand 11). In FIG. 5F, a heater 30, which is a virtual object different from the fish 20, is added to the virtual space. As a result, the scene in the virtual space can be transitioned from the cold scene to the warm scene, and the haptic sensation with no sense of discomfort is presentable to the user 10 (hand 11).

It is assumed that the reason why the haptic device 200 cannot present the haptic sensation corresponding to the situation in FIG. 5C is that the scene in FIG. 5C is a hot scene. When the scene in FIG. 5C is the cold scene, it is assumed that the haptic device 200 can present the haptic sensation corresponding to the touch in FIG. 5C to the user 10 (hand 11). In FIG. 5G, a rain effect is added to the display of the virtual space. As a result, the scene in the virtual space can be transitioned from the hot scene to the cold scene, and the haptic sensation with no sense of discomfort is presentable to the user 10 (hand 11).

A material of the fish 20 is controlled, and thus, the haptic sensation corresponding to the situation of FIG. 5C may be controlled to the haptic sensation that is presentable by the haptic device 200. It is assumed that the haptic device 200 can present a haptic sensation of bubbles to the user 10 (hand 11). In FIG. 5H, the material of the fish 20 is changed to bubbles. As a result, it is possible to present the haptic sensation of bubbles with no sense of discomfort to the user 10 (hand 11). When the user touches the fish 20, the fish 20 disappears after the haptic sensation of bubbles is presented to the user 10 (hand 11).

As described above, according to the present embodiment, the display of the virtual space is controlled such that a predetermined touch corresponding to the haptic sensation that is not presentable to the user from the haptic device to be used does not occur as the touch of the user with the virtual object. As a result, it is possible to suppress presentation of a haptic sensation with a sense of discomfort.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

For example, the control of FIGS. 5D to 5H may be executed in an appropriate combination. In addition, although an example in which determination as to whether or not the intensity of the ultrasonic wave corresponding to the haptic sensation intensity is within a predetermined range is performed as determination as to whether or not the estimated haptic sensation is presentable has been described, the present disclosure is not limited thereto. It may be determined whether or not the haptic sensation intensity (touch intensity) is within the predetermined range, it may be determined whether or not a magnitude of the motion vector is within a predetermined range, or it may be determined whether or not an acceleration (output value of an acceleration sensor) detected by the sensor unit 119 is within a predetermined range. In a case where determination of the motion vector or the acceleration is performed, the collision simulation becomes unnecessary, and a processing load can be reduced. In addition, a determination result as to whether or not the estimated haptic sensation is presentable can be obtained at an earlier timing.

Although an example in which the future touch between the user and the virtual object is predicted has been described, the occurred touch may be evaluated. In this way, the presentation of the haptic sensation with the sense of discomfort can be temporarily performed, but continuous presentation of the sense of discomfort can be suppressed.

Although the example in which the present disclosure is applied to the display device has been described, the information processing apparatus to which the present disclosure is applicable is not limited to the display device. For example, the present disclosure is also applicable to a personal computer or the like connected to the display device. In addition, the information processing apparatus to which the present disclosure is applied may acquire various types of data and information (for example, information of the position and orientation of the user part) which are assumed to be generated in the display device 100 from the outside.

Although an example in which the present disclosure is applied to a case where the aerial haptics is performed has been described, the present disclosure is also applicable to haptic feedback (for example, haptic feedback by vibration of a portion touching the user or temperature modulation) different from the aerial haptics.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-216407, filed Dec. 11, 2024, which is hereby incorporated by reference herein in its entirety.

What is claimed is:

1. An information processing apparatus comprising:
a processor; and
a memory storing a program which, when executed by the processor, causes the information processing apparatus to
execute control processing of controlling display of a virtual space such that a predetermined touch corresponding to a haptic sensation that is not presentable to a user from a haptic device to be used does not occur as a touch of the user with respect to a virtual object in the virtual space.

2. The information processing apparatus according to claim 1,
wherein the program, when executed by the processor, further causes the information processing apparatus to
execute acquisition processing of acquiring information of the haptic device, and
execute estimation processing of predicting a touch of the user with the virtual object and estimating a haptic sensation corresponding to the touch,
wherein, in the control processing, the display of the virtual space is controlled on a basis of the information acquired by the acquisition processing and the haptic sensation estimated by the estimation processing.

3. The information processing apparatus according to claim 2,
wherein the program, when executed by the processor, further causes the information processing apparatus to
execute second acquisition processing of acquiring information of a position and an orientation of a predetermined part of the user, and
in the estimation processing, the prediction of the touch and the estimation of the haptic sensation are performed on a basis of temporal changes in the position and orientation of the predetermined part.

4. The information processing apparatus according to claim 3,
wherein a position and an orientation of the predetermined part in the virtual space are linked with a position and an orientation of the predetermined part in a real space, and
in the second acquisition processing, the predetermined part is detected from an image obtained by imaging the real space.

5. The information processing apparatus according to claim 3,
wherein, in the estimation processing, the prediction of the touch and the estimation of the haptic sensation are performed on a basis of temporal changes in the position and orientation of the predetermined part and temporal changes in a position and an orientation of the virtual object.

6. The information processing apparatus according to claim 3,
wherein the program, when executed by the processor, further causes the information processing apparatus to
execute determination processing of determining whether or not the estimated haptic sensation is a haptic sensation that is presentable from the haptic device to the user on a basis of the information acquired by the acquisition processing and the haptic sensation estimated by the estimation processing, and
in the control processing, the display of the virtual space is controlled on a basis of a determination result of the determination processing.

7. The information processing apparatus according to claim 2,
wherein, in the control processing, in a case where the predetermined touch is predicted, a behavior of the virtual object is controlled such that the touch of the user with the virtual object does not occur.

8. The information processing apparatus according to claim 2,
wherein, in the control processing, in a case where the predetermined touch is predicted, the display of the virtual space is controlled such that the touch of the user with the virtual object, which is not the predetermined touch, is performed.

9. The information processing apparatus according to claim 1,
wherein the control of the display of the virtual space includes control of a behavior of the virtual object.

10. The information processing apparatus according to claim 9,
wherein the control of the behavior of the virtual object is control to cause a predetermined portion of the virtual object to touch the user.

11. The information processing apparatus according to claim 1,
wherein the control of the display of the virtual space includes control to add another virtual object to the virtual space.

12. The information processing apparatus according to claim 1, wherein the control of the display of the virtual space includes control to add an effect to the display of the virtual space.

13. The information processing apparatus according to claim 1,
wherein the control of the display of the virtual space includes control of a material of the virtual object.

14. An information processing method comprising:
displaying a virtual space; and
controlling display of the virtual space such that a predetermined touch corresponding to a haptic sensation that is not presentable to a user from a haptic device to be used does not occur as a touch of the user with respect to a virtual object in the virtual space.

15. A non-transitory computer readable medium that stores a program, wherein the program causes a computer to execute an information processing method comprising:
displaying a virtual space; and
controlling display of the virtual space such that a predetermined touch corresponding to a haptic sensation that is not presentable to a user from a haptic device to be used does not occur as a touch of the user with respect to a virtual object in the virtual space.
